(19) United States
(12) Patent Application Publication
(10) Pub. No.: US 2013/0254762 A1
(43) Pub. Date: Sep. 26, 2013

(54) PROVIDING REDUNDANT VIRTUAL MACHINES IN A CLOUD COMPUTING ENVIRONMENT

(71) Applicant: Marc J. COCHRAN, Shrewsbury, MA (US)

(72) Inventor: Marc J. COCHRAN, Shrewsbury, MA (US)

(73) Assignee: VERIZON PATENT AND LICENSING INC., Basking Ridge, NJ (US)

(21) Appl. No.: 13/425,619

(22) Filed: Mar. 21, 2012

(51) Int. Cl. G06F 9/455

(52) U.S. Cl. 718/1

(57) ABSTRACT

A device designates a primary virtual machine for applications to be executed by the device, and designates a backup virtual machine for the applications. The device also establishes a primary link between the primary virtual machine and each of the applications, and establishes a backup link between the backup virtual machine and each of the applications. The device further determines whether the primary virtual machine is available, and enables, when the primary virtual machine is available, traffic to be securely communicated between the applications via the primary virtual machine and the primary links.

### BACKGROUND

Cloud computing is the delivery of computing as a service rather than as a product, whereby shared resources, software, and information are provided to client devices (e.g., computers, smart phones, etc.) as a utility over a network, such as the Internet. Cloud computing environments provide computation, software, data access, and/or storage services that do not require end-user knowledge of a physical location and configuration of a system that delivers the services.

A data center is a facility used to house computer systems and associated components, such as telecommunication systems and storage systems. A data center generally includes redundant or backup power supplies, redundant data communications connections, environmental controls (e.g., air conditioning, fire suppression, etc.), and/or security devices. In one example, a data center may share information with a cloud computing environment that may be utilized by client devices.

A cloud device in a cloud computing environment may utilize a virtual machine (VM) that includes a software implementation of a machine (e.g., a computer) for executing a program like a physical machine. In one example, a virtual machine may enable applications provided in the cloud device, or in other cloud devices of the cloud computing environment, to communicate with one another. However, if the virtual machine fails, the applications will be unable to communicate with each other.

### BRIEF DESCRIPTION OF THE DRAWINGS

FIG. 1 is a diagram of an example network in which systems and/or methods described herein may be implemented;

FIG. 2 is a diagram of example components of a device that may correspond to one of the devices of the network depicted in FIG. 1;

FIG. 3 is a diagram of example functional components of a data center device of FIG. 1;

FIG. 4 is a diagram of example functional components of a cloud device of FIG. 1;

FIG. 5 is a diagram of example operations capable of being performed by functional components of the cloud device;

FIG. 6 is a diagram of additional example operations capable of being performed by functional components of the cloud device;

FIG. 7 is a diagram of example operations capable of being performed by an example portion of the network depicted in FIG. 1; and

FIG. 8 is a flow chart of an example process for providing redundant virtual machines in a cloud computing environment according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may enable a cloud computing environment to provide redundant virtual machines so that if a primary virtual machine experiences a failure, a redundant or backup virtual machine may perform the functions of the primary virtual machine. In one example implementation, a cloud device in a cloud computing environment may establish a primary virtual machine and a backup virtual machine for applications to be executed by the cloud device. The cloud device may provide primary connections between the primary virtual machine and the applications, and may provide backup connections between the backup virtual machine and the applications. If the primary virtual machine is available, the cloud device may enable traffic to be securely communicated between the applications via the primary virtual machine and the primary connections. If the primary virtual machine is unavailable, the cloud device may enable traffic to be securely communicated between the applications via the backup virtual machine and the backup connections.

As used herein, the term “user” is intended to be broadly interpreted to include a client device, or a user of a client device.

The term “component,” as used herein, is intended to be broadly construed to include hardware (e.g., a processor, a microprocessor, an application-specific integrated circuit (ASIC), a field-programmable gate array (FPGA), a chip, a memory device (e.g., a read only memory (ROM), a random access memory (RAM), etc.), etc.) or a combination of hardware and software (e.g., a processor, microprocessor, ASIC, etc. executing software contained in a memory device).

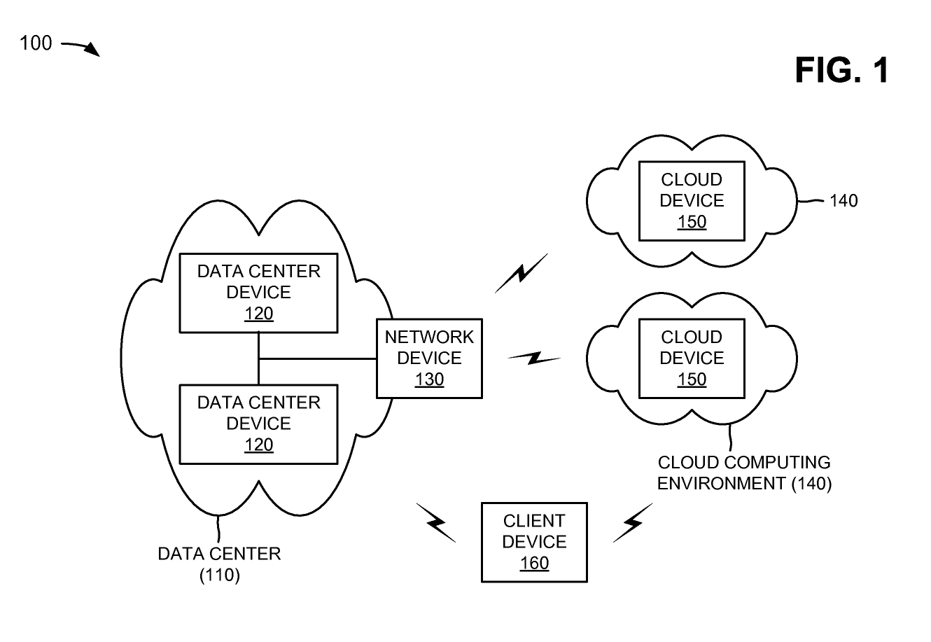

FIG. 1 is a diagram of an example network 100 in which systems and/or methods described herein may be implemented. As illustrated, network 100 may include a data center 110 that includes data center devices 120 and a network device 130; cloud computing environments 140 that include cloud devices 150; and a client device 160. Devices and/or environments of network 100 may interconnect via wired and/or wireless connections. One data center 110, two data center devices 120, one network device 130, two cloud computing environments 140, two cloud devices 150, and one client device 160 have been illustrated in FIG. 1 for simplicity. In practice, there may be more data centers 110, data center devices 120, network devices 130, cloud computing environments 140, cloud devices 150, and/or client devices 160.

Data center 110 may include one or more facilities and/or one or more networks with computer systems, server devices, and associated components, such as telecommunications and storage systems. Data center 110 may include redundant or backup power supplies, redundant data communications connections, environmental controls, security devices, etc. In one example, data center 110 may share information, with cloud computing environment 140, which may be utilized by client device 160. Data center 110 may include resources, such as a device (e.g., a network device, a server, a computer system, etc.), data (e.g., availability information, license information, etc.), a service (e.g., a load balancing service, network information collection, etc.), etc.

Data center device 120 may include one or more server devices, or other types of computation and communication devices, that gather, process, search, and/or provide information in a manner described herein. In one example implementation, data center device 120 may receive shared resources, services, user objects, etc. from cloud computing environments 140 and/or cloud devices 150.

Network device 130 may include a gateway, a router, a switch, a firewall, a network interface card (NIC), a hub, a bridge, a proxy server, a multiplexer, or some other type of device that processes and/or transfers traffic. In one example implementation, network device 130 may include a firewall that creates encrypted tunnels with cloud devices 150 so that secure data paths may be provided between data center devices 120 and cloud devices 150.

Cloud computing environment 140 may include an environment that delivers computing as a service, whereby shared resources, services, user objects, etc. may be provided to data center device 120 and/or client device 160 as a utility over a network. Cloud computing environment 140 may provide computation, software, data access, and/or storage services that do not require end-user (e.g., data center device 120 and/or client device 160) knowledge of a physical location and configuration of system(s) and/or device(s) that deliver the services. In one implementation, cloud computing environment 140 may include a data center similar to data center 110.

Cloud device 150 may include one or more server devices, or other types of computation and communication devices, that gather, process, search, and/or provide information in a manner described herein. In one example implementation, cloud device 150 may provide cloud resources, cloud services, cloud user objects, etc. to data center device 120 and/or client device 160 as a utility over a network.

The cloud resources may include a compute instance executing in cloud device 150, a storage device provided in cloud device 150, a data transfer operation executed by cloud device 150, etc. The cloud services may include a virtual machine executing in cloud device 150, a virtual tunnel provided between network device 130 and cloud device 150, etc. The cloud user objects may include a server (e.g., a virtual machine of cloud device 150) that is managed by data center device 120.

Client device 160 may include a radiotelephone; a personal communications system (PCS) terminal that may combine, for example, a cellular radiotelephone with data processing and data communications capabilities; a smart phone; a personal digital assistant (PDA) that can include a radiotelephone, a pager, Internet/intranet access, etc.; a laptop computer; a tablet computer; a desktop computer; a workstation computer; or other types of computation and communication devices.

Although FIG. 1 shows example devices/networks of network 100, in other implementations, network 100 may include fewer devices/networks, different devices/networks, differently arranged devices/networks, or additional devices/networks than depicted in FIG. 1. Alternatively, or additionally, one or more devices/networks of network 100 may perform one or more tasks described as being performed by one or more other devices/networks of network 100.

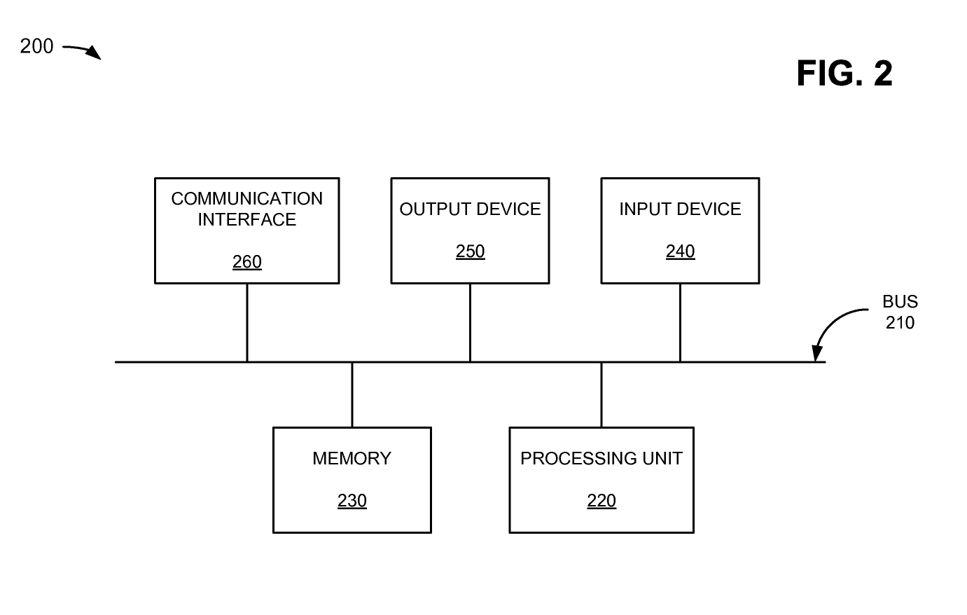

FIG. 2 is a diagram of example components of a device 200 that may correspond to one or more devices of network 100 (FIG. 1). In one example implementation, one or more of the devices of network 100 may include one or more devices 200 or one or more components of device 200. As illustrated in FIG. 2, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. In other implementations, processing unit 220 may be implemented as or include one or more ASICs, FPGAs, or the like.

Memory 230 may include a RAM or another type of dynamic storage device that stores information and instructions for execution by processing unit 220, a ROM or another type of static storage device that stores static information and instructions for the processing unit 220, and/or some other type of magnetic or optical recording medium and its corresponding drive for storing information and/or instructions.

Input device 240 may include a device that permits an operator to input information to device 200, such as a keyboard, a keypad, a mouse, a pen, a microphone, a touch screen display, one or more biometric mechanisms, and the like. Output device 250 may include a device that outputs information to the operator, such as a display, a speaker, etc.

Communication interface 260 may include any transceiver-like mechanism that enables device 200 to communicate with other devices and/or systems. For example, communication interface 260 may include mechanisms for communicating with other devices, such as other devices of network 100.

As described herein, device 200 may perform certain operations in response to processing unit 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device via communication interface 260. The software instructions contained in memory 230 may cause processing unit 220 to perform processes described herein. Alternatively, or additionally, hardwired circuitry may be used in place of or in combination with software instructions to implement processes described herein. Thus, implementations described herein are not limited to any specific combination of hardware circuitry and software.

Although FIG. 2 shows example components of device 200, in other implementations, device 200 may include fewer components, different components, differently arranged components, or additional components than depicted in FIG. 2. Alternatively, or additionally, one or more components of device 200 may perform one or more tasks described as being performed by one or more other components of device 200.

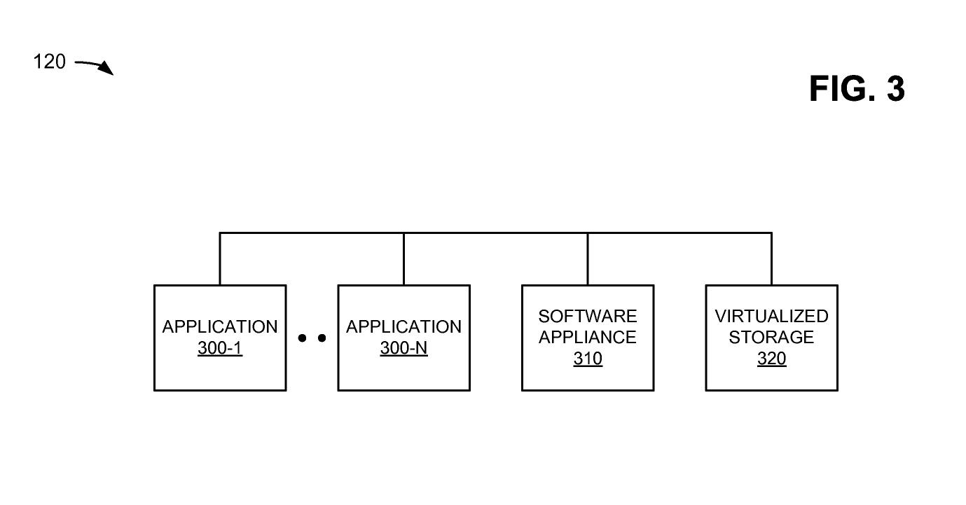

FIG. 3 is a diagram of example functional components of data center device 120. In one implementation, the functions described in connection with FIG. 3 may be performed by one or more components of device 200 (FIG. 2) or by one or more devices 200. As shown in FIG. 3, data center device 120 may include multiple applications 300-1 through 300-N (collectively referred to herein as “applications 300,” and, in some instances, singularly as “application 300”), a software appliance 310, and virtualized storage 320.

Applications 300 may include one or more software applications, available at data center device 120, which may depend upon the function of data center device 120. For example, applications 300 may include software that handles core business and operational data of an organization, enterprise software, telecommunications software, etc. Applications 300 may be designed for execution by multiple host devices, where each host device may execute a single component. In one example, components of applications 300 may include databases, file servers, application servers, middleware, etc.

Software appliance 310 may securely bridge data center device 120 with cloud computing services provided by cloud computing environment 140. Software appliance 310 may extend data center 110 security and control into cloud computing environment 140. This may allow applications 300 to remain integrated with data center 110 tools and policies and to be managed as if applications 300 were executing locally. Software appliance 310 may move applications 300 between data center 110 and cloud computing environment 140 based on requirements of an organization. In one example, software appliance 310 may include management components for discovering applications 300, orchestrating cloud deployments, and/or managing cloud utilization. Software appliance 310 may create a secure data path to bridge network connectivity between data center 110 and a chosen provider of cloud computing environment 140. In one example implementation, data center device 120 may utilize multiple software appliances 310 for availability and scaling purposes.

Virtualized storage 320 may include one or more storage systems and/or one or more devices that use virtualization techniques to enable better functionality and more advanced features within the storage systems and/or the devices of data center device 120. In one example, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system greater flexibility in how they manage storage for end users. File virtualization may eliminate dependencies between data accessed at a file level and a location where files are physically stored. This may enable optimization of storage use, server consolidation, and/or performance of non-disruptive file migrations.

Although FIG. 3 shows example functional components of data center device 120, in other implementations, data center device 120 may include fewer functional components, different functional components, differently arranged functional components, or additional functional components than depicted in FIG. 3. Additionally, or alternatively, one or more functional components of data center device 120 may perform one or more tasks described as being performed by one or more other functional components of data center device 120.

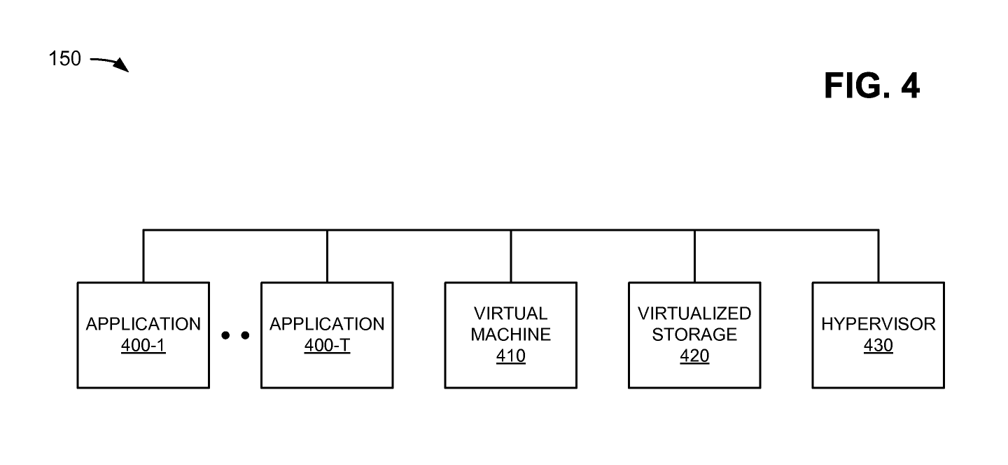

FIG. 4 is a diagram of example functional components of cloud device 150. In one implementation, the functions described in connection with FIG. 4 may be performed by one or more components of device 200 (FIG. 2) or by one or more devices 200. As shown in FIG. 4, cloud device 150 may include multiple applications 400-1 through 400-T (collectively referred to herein as “applications 400,” and, in some instances, singularly as “application 400”), a virtual machine 410, virtualized storage 420, and a hypervisor 430.

Applications 400 may include one or more software applications that may be provided to or accessed by client device 160. Applications 400 may eliminate a need to install and execute the software applications on client device 160. For example, applications 400 may include word processing software, database software, content, monitoring software, financial software, communication software, and/or any other software capable of being provided via cloud computing environment 140. In one example implementation, one application 400 may communicate information (e.g., traffic) with one or more other applications 400, via virtual machine 410.

Virtual machine (VM) 410 may include a software implementation of a machine (e.g., a computer) that executes programs like a physical machine. Virtual machine 410 may be either a system virtual machine or a process virtual machine, depending upon use and degree of correspondence to any real machine by virtual machine 410. A system virtual machine may provide a complete system platform that supports execution of a complete operating system (OS). A process virtual machine may execute a single program, and may support a single process. In one example implementation, virtual machine 410 may execute on behalf of a data center 110 user (e.g., client device 160), and may manage infrastructure of cloud computing environment 140, such as data management, synchronization, and long-duration data transfers. Virtual machine 410 may provide encryption services for network and storage utilization to ensure that cloud computing environment providers do not have access to data center 110 network or storage communications.

Virtualized storage 420 may include one or more storage systems and/or one or more devices that use virtualization techniques to enable better functionality and more advanced features within the storage systems or devices of cloud device 150. In one example, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system greater flexibility in how they manage storage for end users. File virtualization may eliminate dependencies between data accessed at a file level and a location where files are physically stored. This may enable optimization of storage use, server consolidation, and/or performance of non-disruptive file migrations.

Hypervisor 430 may provide hardware virtualization techniques that allow multiple operating systems (e.g., “guest operating systems”) to execute concurrently on a host computer. Hypervisor 430 may present to the guest operating systems a virtual operating platform, and may manage the execution of the guest operating systems. Multiple instances of a variety of operating systems may share virtualized hardware resources. Hypervisor 430 may provide an interface to infrastructure as a service (IaaS) provided by cloud computing environment 140.

Although FIG. 4 shows example functional components of cloud device 150, in other implementations, cloud device 150 may include fewer functional components, different functional components, differently arranged functional components, or additional functional components than depicted in FIG. 4. Additionally, or alternatively, one or more functional components of cloud device 150 may perform one or more tasks described as being performed by one or more other functional components of cloud device 150.

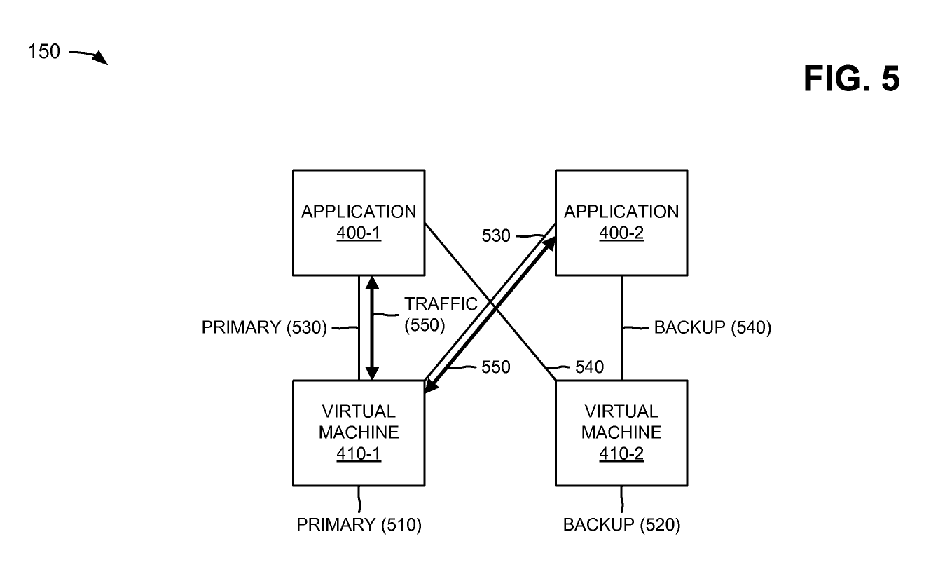

FIG. 5 is a diagram of example operations capable of being performed by functional components of cloud device 150. As shown, cloud device 150 may include a first application 400-1, a second application 400-2, a first virtual machine 410-1, and a second virtual machine 410-2. Cloud device 150, first application 400-1, second application 400-2, first virtual machine 410-1, and second virtual machine 410-2 may include the features described above in connection with, for example, one or more of FIGS. 1, 2, and 4.

In one example implementation, cloud device 150 may execute a continuous loop protocol, such as, for example, a spanning tree protocol. The spanning tree protocol may ensure a loop-free topology for any bridged Ethernet local area network, and may prevent bridge loops. The spanning tree protocol may permit a network design to include backup or redundant links that provide automatic backup paths if an active or primary link fails, without the danger of bridge loops, or the need for manual enabling/disabling of the backup links.

As further shown in FIG. 5, cloud device 150, via the continuous loop protocol (e.g., the spanning tree protocol), may designate first virtual machine 410-1 as a primary virtual machine 510, and may designate second virtual machine 410-2 as a redundant or backup virtual machine 520. In one example, primary virtual machine 510 may enable secure (e.g., encrypted) communication of information, such as traffic, between first application 400-1 and second application 400-2. The term traffic, as used herein, is intended to be broadly construed to include a frame, a datagram, a packet, or a cell; a fragment of a frame, a fragment of a datagram, a fragment of a packet, or a fragment of a cell; or another type, arrangement, or packaging of data. Backup virtual machine 520, via the continuous loop protocol, may provide the functionality provided by primary virtual machine 510 when primary virtual machine 510 is unavailable (e.g., due to failure). For example, when primary virtual machine 510 is unavailable, backup virtual machine 520 may enable encrypted communication of information, such as traffic, between first application 400-1 and second application 400-2.

In one example implementation, the continuous loop protocol may enable cloud device 150 to determine whether primary virtual machine 510 is available. The continuous loop protocol may know when traffic sent out on a port is not received on another port. This could be due to a receiving virtual machine being unavailable, a process on the receiving virtual machine being unavailable, a link being unavailable, etc. For example, if primary virtual machine 510 is available, the continuous loop protocol may enable applications 400-1 and 400-2 to securely exchange traffic via primary virtual machine 510. However, if primary virtual machine 510 is unavailable (e.g., due to failure), the continuous loop protocol may return traffic from applications 400-1 and 400-2 that is destined for primary virtual machine 510. When applications 400-1 and 400-2 receive the returned traffic, applications 400-1 and 400-2 may securely provide the traffic to backup virtual machine 520, and backup virtual machine 520 may securely forward the traffic to one of applications 400-1 and 400-2. In one example, if applications 400-1/400-2 do not receive traffic due to primary virtual machine 510 being unavailable, the continuous loop protocol may mark primary virtual machine 510 as unavailable, which may result in backup virtual machine 520 being used.

Cloud device 150, via the continuous loop protocol, may establish primary connections 530 between primary virtual machine 510 and applications 400-1 and 400-2, and may establish backup connections 540 between backup virtual machine 520 and applications 400-1 and 400-2. Primary connections 530 may include links and may enable applications 400-1 and 400-2 to exchange traffic 550 via primary virtual machine 510, when primary virtual machine 510 is available. Backup connections 540 may include links and may enable applications 400-1 and 400-2 to exchange traffic 550 via backup virtual machine 520, when primary virtual machine 510 is unavailable.

Although FIG. 5 shows example operations capable of being performed by functional components of cloud device 150, in other implementations, cloud device 150 may include fewer functional components, different functional components, differently arranged functional components, or additional functional components than depicted in FIG. 5. Additionally, or alternatively, one or more functional components of cloud device 150 may perform one or more tasks described as being performed by one or more other functional components of cloud device 150.

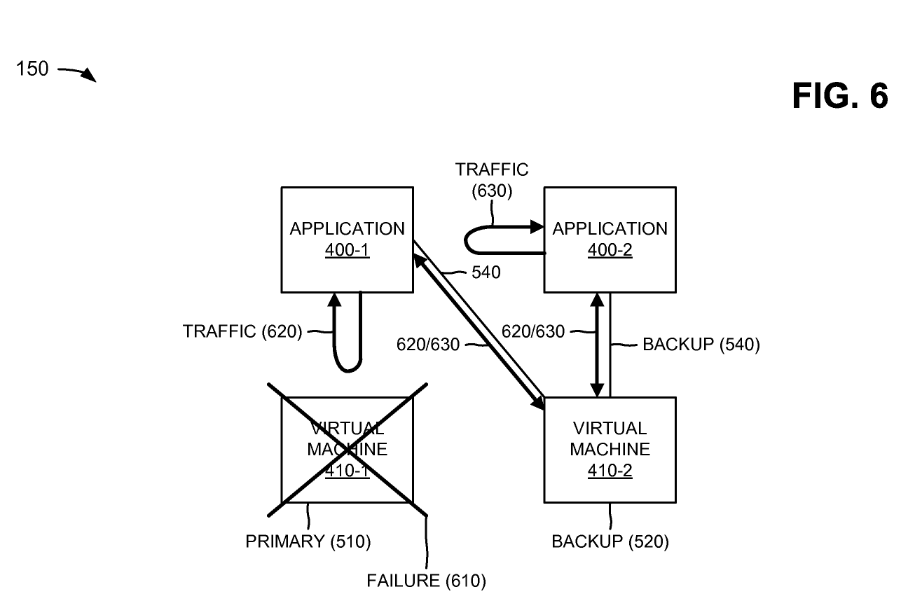

FIG. 6 is a diagram of additional example operations capable of being performed by functional components of cloud device 150. As shown, cloud device 150 may include first application 400-1, second application 400-2, first virtual machine 410-1, and second virtual machine 410-2. First virtual machine 410-1 may be designated as primary virtual machine 510, and second virtual machine 410-2 may be designated as backup virtual machine 520. Backup connections 540 may be provided between backup virtual machine 520 and applications 400-1 and 400-2. Cloud device 150, first application 400-1, second application 400-2, first virtual machine 410-1, second virtual machine 410-2, primary virtual machine 510, backup virtual machine 520, and backup connections 540 may include the features described above in connection with, for example, one or more of FIGS. 1, 2, 4, and 5. In one example implementation, cloud device 150 may execute a continuous loop protocol, such as, for example, a spanning tree protocol.

As further shown in FIG. 6, primary virtual machine 510 may experience a failure 610 and become unavailable. When primary virtual machine 510 experiences failure 610, first application 400-1 may be unable to provide traffic 620 to primary virtual machine 510, and second application 400-2 may be unable to provide traffic 630 to primary virtual machine 510. Traffic 620 may be destined for second application 400-2, whereas traffic 630 may be destined for first application 400-1. The continuous loop protocol may cause traffic 620 to be returned to first application 400-1, and may cause traffic 630 to be returned to second application 400-2. When traffic 620 is returned to first application 400-1, first application 400-1 may utilize backup connections 540 to provide traffic 620 to second application 400-2, via backup virtual machine 520. In one example, first application 400-1 may know to utilize backup connections 540 based on the continuous loop protocol. When traffic 630 is returned to second application 400-2, second application 400-2 may utilize backup connections 540 to provide traffic 630 to first application 400-1, via backup virtual machine 520. In one example, second application 400-2 may know to utilize backup connections 540 based on the continuous loop protocol.

Backup virtual machine 520 and backup connections 540 may enable applications 400-1 and 400-2 to exchange traffic 620/630, in an encrypted manner, until primary virtual machine 510 becomes available again. In one example, once primary virtual machine 510 becomes available, primary virtual machine 510 and primary connections 530 (not shown in FIG. 6) may enable applications 400-1 and 400-2 to exchange traffic 620/630, in an encrypted manner. Alternatively, or additionally, backup virtual machine 520 and backup connections 540 may continue to enable applications 400-1 and 400-2 to exchange traffic 620/630, in an encrypted manner, until backup virtual machine 520 becomes unavailable. When backup virtual machine 520 becomes unavailable, primary virtual machine 510 and primary connections 530 (not shown in FIG. 6) may enable applications 400-1 and 400-2 to exchange traffic 620/630, in an encrypted manner.

Although FIG. 6 shows example operations capable of being performed by functional components of cloud device 150, in other implementations, cloud device 150 may include fewer functional components, different functional components, differently arranged functional components, or additional functional components than depicted in FIG. 6. Additionally, or alternatively, one or more functional components of cloud device 150 may perform one or more tasks described as being performed by one or more other functional components of cloud device 150.

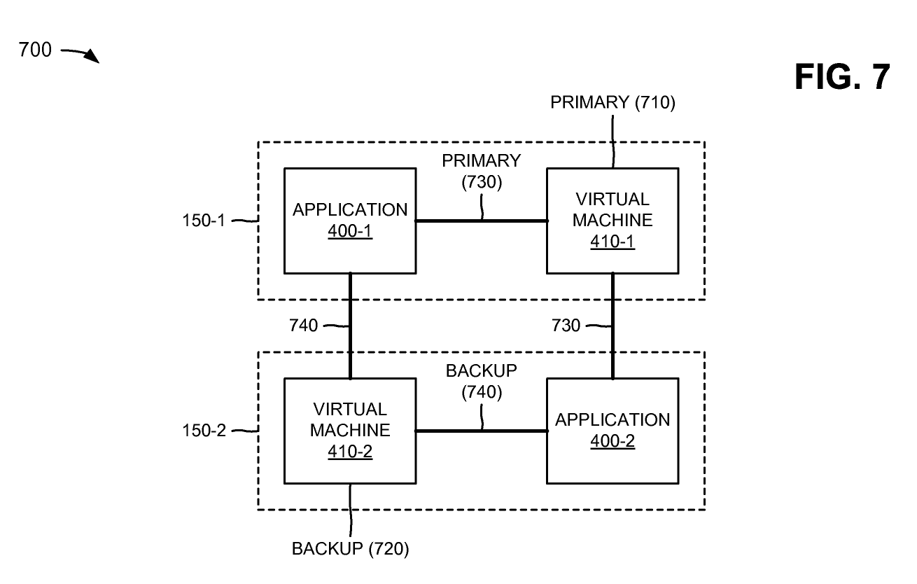

FIG. 7 is a diagram of example operations capable of being performed by an example portion 700 of network 100 (FIG. 1). As shown, example network portion 700 may include a first cloud device 150-1 and a second cloud device 150-2. First cloud device 150-1 may include first application 400-1 and first virtual machine 410-1, and second cloud device 150-2 may include second application 400-2 and second virtual machine 410-2. First cloud device 150-1, second cloud device 150-2, first application 400-1, first virtual machine 410-1, second application 400-2, and second virtual machine 410-2 may include the features described above in connection with, for example, one or more of FIGS. 1, 2, and 4-6. In one example implementation, cloud devices 150-1 and 150-2 may execute a continuous loop protocol, such as, for example, a spanning tree protocol.

As further shown in FIG. 7, cloud devices 150-1 and 150-2, via the continuous loop protocol, may designate first virtual machine 410-1 as a primary virtual machine 710, and may designate second virtual machine 410-2 as a redundant or backup virtual machine 720. In one example, primary virtual machine 710 may enable encrypted communication of information, such as traffic, between first application 400-1 and second application 400-2. Backup virtual machine 720, via the continuous loop protocol, may provide the functionality provided by primary virtual machine 710 when primary virtual machine 710 is unavailable (e.g., due to failure). For example, when primary virtual machine 710 is unavailable, backup virtual machine 720 may enable encrypted communication of information, such as traffic, between first application 400-1 and second application 400-2.

Cloud devices 150-1 and 150-2, via the continuous loop protocol, may establish primary connections 730 between primary virtual machine 710 and applications 400-1 and 400-2, and may establish backup connections 740 between backup virtual machine 720 and applications 400-1 and 400-2. Primary connections 730 may include links and may enable applications 400-1 and 400-2 to exchange traffic in an encrypted manner, via primary virtual machine 710, when primary virtual machine 710 is available. Backup connections 740 may include links and may enable applications 400-1 and 400-2 to exchange traffic in an encrypted manner, via backup virtual machine 720, when primary virtual machine 710 is unavailable.

Although FIG. 7 shows example operations capable of being performed by components of example network portion 700, in other implementations, example network portion 700 may include fewer components, different components, differently arranged components, or additional components than depicted in FIG. 7. Additionally, or alternatively, one or more components of example network portion 700 may perform one or more tasks described as being performed by one or more other components of example network portion 700.

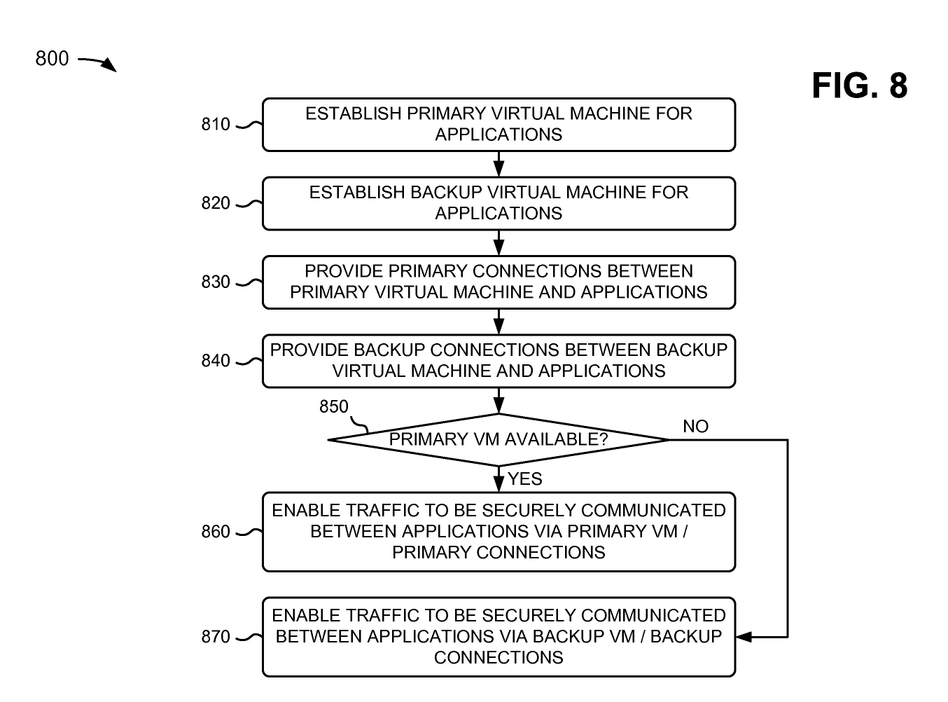

FIG. 8 is a flow chart of an example process 800 for providing redundant virtual machines in a cloud computing environment according to an implementation described herein. In one implementation, process 800 may be performed by one or more cloud devices 150. Alternatively, or additionally, some or all of process 800 may be performed by another device or group of devices, including or excluding one or more cloud devices 150.

As shown in FIG. 8, process 800 may include establishing a primary virtual machine for applications (block 810), and establishing a backup virtual machine for the applications (block 820). For example, in an implementation described above in connection with FIG. 5, cloud device 150, via the continuous loop protocol (e.g., the spanning tree protocol), may designate first virtual machine 410-1 as primary virtual machine 510, and may designate second virtual machine 410-2 as redundant or backup virtual machine 520. In one example, primary virtual machine 510 may enable encrypted communication of information, such as traffic, between first application 400-1 and second application 400-2. Backup virtual machine 520, via the continuous loop protocol, may provide the functionality provided by primary virtual machine 510 when primary virtual machine 510 is unavailable (e.g., due to failure).

As further shown in FIG. 8, process 800 may include providing primary connections between the primary virtual machine and the applications (block 830), and providing backup connections between the backup virtual machine and the applications (block 840). For example, in an implementation described above in connection with FIG. 5, cloud device 150, via the continuous loop protocol, may establish primary connections 530 between primary virtual machine 510 and applications 400-1 and 400-2, and may establish backup connections 540 between backup virtual machine 520 and applications 400-1 and 400-2. Primary connections 530 may include links and may enable applications 400-1 and 400-2 to exchange traffic 550 via primary virtual machine 510, when primary virtual machine 510 is available. Backup connections 540 may include links and may enable applications 400-1 and 400-2 to exchange traffic via backup virtual machine 520, when primary virtual machine 510 is unavailable.

Returning to FIG. 8, process 800 may include determining whether the primary virtual machine (VM) is available (block 850). If the primary virtual machine is available (block 850—YES), process 800 may include enabling traffic to be securely communicated between the applications via the primary virtual machine and the primary connections (block 860). For example, in an implementation described above in connection with FIG. 5, the continuous loop protocol may enable cloud device 150 to determine whether primary virtual machine 510 is available. In one example, if primary virtual machine 510 is available, such as when the continuous loop protocol does not return traffic to applications 400-1 and 400-2, the continuous loop protocol may enable applications 400-1 and 400-2 to securely exchange traffic via primary virtual machine 510. Primary connections 530 may enable applications 400-1 and 400-2 to exchange traffic 550 via primary virtual machine 510, when primary virtual machine 510 is available.

As further shown in FIG. 8, if the primary virtual machine is unavailable (block 850—NO), process 800 may include enabling traffic to be securely communicated between the applications via the backup virtual machine and the backup connections (block 870). For example, in an implementation described above in connection with FIG. 5, if primary virtual machine 510 is unavailable (e.g., due to failure), the continuous loop protocol may return traffic from applications 400-1 and 400-2 that is destined for primary virtual machine 510. When applications 400-1 and 400-2 receive the returned traffic, applications 400-1 and 400-2 may securely provide the traffic to backup virtual machine 520, and backup virtual machine 520 may securely forward the traffic to one of applications 400-1 and 400-2. Backup connections 540 may enable applications 400-1 and 400-2 to exchange traffic 550 via backup virtual machine 520, when primary virtual machine 510 is unavailable.

Systems and/or methods described herein may enable a cloud computing environment to provide redundant virtual machines so that if a primary virtual machine experiences a failure, a redundant or backup virtual machine may perform the functions of the primary virtual machine. In one example implementation, a cloud device in a cloud computing environment may establish a primary virtual machine and a backup virtual machine for applications to be executed by the cloud device. The cloud device may provide primary connections between the primary virtual machine and the applications, and may provide backup connections between the backup virtual machine and the applications. If the primary virtual machine is available, the cloud device may enable traffic to be securely communicated between the applications via the primary virtual machine and the primary connections. If the primary virtual machine is unavailable, the cloud device may enable traffic to be securely communicated between the applications via the backup virtual machine and the backup connections.

The foregoing description of implementations provides illustration and description, but is not intended to be exhaustive or to limit the implementations to the precise form disclosed. Modifications and variations are possible in light of the above disclosure or may be acquired from practice of the implementations.

For example, while a series of blocks has been described with regard to FIG. 8, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
establishing, by a device, a primary virtual machine for applications to be executed by the device;
establishing, by the device, a backup virtual machine for the applications;
providing, by the device, a primary connection between the primary virtual machine and each of the applications;
providing, by the device, a backup connection between the backup virtual machine and each of the applications;
determining, by the device, whether the primary virtual machine is available; and
enabling, by the device and when the primary virtual machine is available, traffic to be securely communicated between the applications via the primary virtual machine and the primary connections.

2. The method of claim 1, further comprising:
enabling, when the primary virtual machine is unavailable, the traffic to be securely communicated between the applications via the backup virtual machine and the backup connections.

3. The method of claim 2, further comprising:
enabling, when the primary virtual machine becomes available again after the primary virtual machine is unavailable, additional traffic to be securely communicated between the applications via the primary virtual machine and the primary connections.

4. The method of claim 1, where the device utilizes a continuous loop protocol to establish the primary virtual machine and the backup virtual machine.

5. The method of claim 4, where the continuous loop protocol includes a spanning tree protocol.

6. The method of claim 1, where enabling the traffic to be securely communicated between the applications further comprises:
encrypting the traffic; and
providing the encrypted traffic to the applications via the primary virtual machine and the primary connections.

7. The method of claim 1, where the device includes a cloud computing environment device.

8. A device, comprising:
a processor to:
designate a primary virtual machine for applications to be executed by the device,
designate a backup virtual machine for the applications,
establish a primary link between the primary virtual machine and each of the applications,
establish a backup link between the backup virtual machine and each of the applications,
determine whether the primary virtual machine is available, and
enable, when the primary virtual machine is available, traffic to be securely communicated between the applications via the primary virtual machine and the primary links.

9. The device of claim 8, where the processor is further to:
enable, when the primary virtual machine is unavailable, the traffic to be securely communicated between the applications via the backup virtual machine and the backup links.

10. The device of claim 9, where the processor is further to:
enable, when the primary virtual machine becomes available again after the primary virtual machine is unavailable, additional traffic to be securely communicated between the applications via the primary virtual machine and the primary links.

11. The device of claim 8, where the device utilizes a continuous loop protocol to establish the primary links and the backup links.

12. The device of claim 11, where the continuous loop protocol includes a spanning tree protocol.

13. The device of claim 8, where, when enabling traffic to be securely communicated between the applications, the processor is further to:
encrypt the traffic, and
enable the encrypted traffic to be communicated between the applications via the primary virtual machine and the primary connections.

14. The device of claim 8, where the device is provided in a cloud computing environment.

15. A computer-readable medium, comprising:
one or more instructions that, when executed by one or more processors of a device, cause the one or more processors to:
designate a primary virtual machine for applications to be executed by the device,
designate a backup virtual machine for the applications,
establish a primary connection between the primary virtual machine and each of the applications,
establish a backup connection between the backup virtual machine and each of the applications,
determine whether the primary virtual machine is available, and
enable, when the primary virtual machine is available, traffic to be securely communicated between the applications via the primary virtual machine and the primary connections.

16. The computer-readable medium of claim 15, further comprising:
one or more instructions that, when executed by the one or more processors of the device, cause the one or more processors to:
enable, when the primary virtual machine is unavailable, the traffic to be securely communicated between the applications via the backup virtual machine and the backup connections.

17. The computer-readable medium of claim 16, further comprising:
one or more instructions that, when executed by the one or more processors of the device, cause the one or more processors to:
enable, when the primary virtual machine becomes available again after the primary virtual machine is unavailable, additional traffic to be securely communicated between the applications via the primary virtual machine and the primary connections.

18. The computer-readable medium of claim 15, where the device utilizes a continuous loop protocol to:
designate the primary virtual machine and the backup virtual machine, and
establish the primary connections and the backup connections.

19. The computer-readable medium of claim 18, where the continuous loop protocol includes a spanning tree protocol.

20. The computer-readable medium of claim 15, further comprising:
one or more instructions that, when executed by the one or more processors of the device, cause the one or more processors to:
encrypt the traffic, and
provide the encrypted traffic to the applications via the primary virtual machine and the primary connections.
